(19) United States
(12) Patent Application Publication
(10) Pub. No.: US 2004/0033295 A1
(43) Pub. Date: Feb. 19, 2004

(54) Buffered meal component and a kit for making a meal

(75) Inventors: Kenneth Gimelli, Waldwick, NJ (US); Daniel Thomas Sullivan, West Milford, NJ (US)

Correspondence Address: UNILEVER, PATENT DEPARTMENT, 45 RIVER ROAD, EDGEWATER, NJ, 07020, US

(73) Assignee: Unilever Bestfoods

(21) Appl. No.: 10/223,207

(22) Filed: Aug. 19, 2002

(51) Int. Cl. A23B 4/00

(52) U.S. Cl. 426/120

(57) ABSTRACT

A buffered meal component and a kit comprising the buffered meal component and a sauce are described. The sauce has an acidic pH that is increased by the buffered meal component during cooking to produce a fresh looking and tasting meal that can be prepared in under 40 minutes.

### FIELD OF THE INVENTION

The present invention is directed to a buffered meal component, like buffered pasta. More particularly, the present invention is directed to a kit comprising a buffered meal component, like buffered pasta, whereby a pasta dish may be prepared from the same without having to first boil the pasta in water. The kit of the present invention is suitable for cooking a meal component in a sauce that has not been subjected to temperatures that exceed about 100° C., and unexpectedly results in a meal (including side dish or snack) that looks and tastes fresh.

### BACKGROUND OF THE INVENTION

Consumers, today, typically have very busy schedules, and especially, during the work week. Because of these schedules, many consumers often do not have the time and energy to prepare a home cooked meal. Quick-to-prepare meals have been developed in order to give the consumer with a hectic schedule a chance to cook and prepare a hot meal. These quick-to-prepare meals are often in the form of TV dinners and microwavable dinners, as well as meals packaged in bags suitable for boiling. Such meals, while quick to prepare, often do not look and taste fresh like a home cooked meal; therefore, loose consumer interest.

Other options for a busy consumer include take-out meals and fast foods. These options have drawbacks since they can be expensive and often do not meet the standards required for a healthy and balanced diet.

There are increasing interests for meals that are fast and easy to prepare, yet offer the look, taste and freshness of a home cooked meal. This invention, therefore, is directed to a buffered meal component suitable for use in a kit that results in a fresh-tasting meal. The kit comprises, in addition to buffered meal component, a sauce that has not been subjected to temperatures that exceed about 100° C. Moreover, the meal that is prepared from the kit of this invention may be ready for serving in less than about 40 minutes.

Additional Information

Efforts have been made to provide pasta dishes. In U.S. Pat. No. 6,004,608, a flexible packaging system with spiral wound instant pasta noodles is described.

Other efforts have been made to provide pasta dishes. In U.S. Pat. No. 5,738,876, dry, spiral shaped pasta compositions are described.

Still other efforts have been disclosed that describe pasta dishes. In U.S. Pat. No. 5,411,752, pasta-based food products prepared with soy protein or egg white binding agents are described.

None of the additional information above describes a meal having been prepared from a buffered meal component and a sauce that has not been subjected to temperatures that exceed about 100° C.

### SUMMARY OF THE INVENTION

In a first aspect, the present invention is directed to a buffered meal component.

In a second aspect, the present invention is directed to a kit comprising:

a) a buffered meal component;

b) a sauce;

c) instructions to combine the buffered meal component with the sauce and a liquid to produce a mixture comprising buffered meal component; and

d) instructions to cook the mixture comprising the buffered meal component.

In a third aspect, the present invention is directed to a method for making a meal with the kit of the second aspect of this invention.

In a fourth aspect, the present invention is directed a meal made via the method of the third aspect of this invention.

Meal component, as used herein, is defined to mean a predominant component in a meal wherein the meal component is suitable to be buffered with a buffering agent (i.e., a precursor to a buffered meal component) and preferably solid before and after the meal is cooked.

Suitable to be buffered, as used herein, is defined to mean a meal component suitable to behave or act as a carrier, substrate or both for a buffering agent to thereby result in a buffered meal component.

Cook, as used herein, includes preparing on a stove top, microwave oven and baking in an oven.

Not subjected to temperatures that exceed about 100° C., means that the sauce used in this invention is not heated to temperatures that exceed about 100° C. before they are actually cooked for serving.

### DETAILED DESCRIPTION OF THE PREFERRED EMBODIMENTS

The only limitation with respect to the meal component that may be used in this invention is that, after cooking, the meal component is suitable for human consumption. Illustrative examples of the meal component that may be used in this invention include carbohydrate-based products, meats, vegetables, fruits, mixtures thereof or the like. In a preferred embodiment, the carbohydrate-based products are pasta, pasta-based products (including egg noodles), rice, potato, potato-based products (including gnocchi), matzo ball, dumplings, couscous, mixtures thereof or the like. In yet another preferred embodiment, the meats employed in this invention are beef, poultry, pork, lamb, fish, mixtures thereof or the like. The preferred vegetables for use in the present invention include squash, corn, peas, cauliflower, broccoli, carrots, mixtures thereof or the like. As to the fruits preferred for use in this invention, such fruits include dates, prunes, figs, tomatoes, apples, grapes, mixtures thereof or the like.

The buffering agent that may be used in this invention includes any of those generally classified as suitable for use with a food product. Such a buffering agent can include sodium citrate, sodium malate, sodium phosphate, disodium phosphate, sodium carbonate, sodium hexametaphosphate, potassium citrate, potassium phosphate, potassium carbonate, potassium bicarbonate, potassium hexametaphosphate, potassium malate, glucono-delta lactone, buffering salts of food acids, mixtures thereof or the like.

There is essentially no limitation with respect to how the buffered meal component of the present invention is made or prepared as long as the meal component functions as a carrier or substrate for the buffering agent. If pasta, for example, is the desired meal component, the buffering agent or agents employed in this invention may be added to conventional ingredients used to make pasta (e.g., water, semolina, flour and salt), thoroughly mixed with the same and then extruded to make the pasta (i.e., buffered meal component) of desired shape. A similar technique may also be used with any of the meal components described above that are suitable for mixing with the buffering agent. Thus, for instance, buffering agent may be mixed with potato, matzo meal, as well as flour and/or corn starch used to make dumplings.

Another option for making the buffered meal component of the present invention includes rolling or physically contacting the meal component with buffering agent, as well as spraying a solution (e.g., aqueous solution) with buffering agent on to the surface of the meal component. Often, when it is not possible for the buffering agent to be mixed or added to conventional ingredients used to make the meal component (e.g., as is the case with chunks of meat, vegetables and fruit), the buffering agent may be applied to the meal component during a typical individually quick frozen (IQF) process.

The amount of buffering agent employed to make the buffered meal component of the present invention is typically from about 0.10% to about 3.0%, and preferably, from about 0.15% to about 2.75%, and most preferably, from about 0.2% to about 2.25% by weight, based on total weight of the buffered meal component, and including all ranges subsumed therein.

There is no limitation with respect to the type of sauce used in this invention other than that the sauce is suitable for human consumption. Such a sauce may be an alfredo-based sauce, a teriyaki-based sauce, a cheddar cheese-based sauce, a tomato-based sauce and the like. The sauces may be made with their characteristic and conventional ingredients; however, with the proviso that the sauces, which are not subjected to temperatures that exceed about 100° C., comprise enough of a pH modifier to ensure that they have a pH from about 3.5 to about 4.5, and preferably, from about 3.6 to about 4.4, and most preferably, from about 3.8 to about 4.3, including all ranges subsumed therein.

The pH modifiers that may be used are typically food grade acids like citric acid, acetic acid, phosphoric acid, malic acid, lactic acid, mixtures thereof or the like. In addition to pH modifiers, preservatives (i.e., about 0.002% to about 0.2% by weight of the total weight of the sauce) may also be used in order to assist in rendering the sauces employed in this invention stable in the absence of heating the same to temperatures that exceed about 100° C.

Optional additives which may be used in the sauces employable in this invention include sugar, salt, cheese, spices, granulated vegetables, mixtures thereof or the like. The amount of optional additives employed is limited only to the extent that it does not cause the sauce of choice to have a pH over about 4.5; and therefore, the general amount of such optional additives used is a matter of taste.

The kit of the present invention typically has about 1.0 part of buffered meal component for about every 0.5 to about 1.5 parts of sauce, whereby parts are parts by weight and the buffered meal component and sauce do not come into contact with each other when packaged as a kit for sale. After purchasing the kit of the present invention, the consumer will be instructed, in no particular order, to combine (preferably while stirring) the buffered meal component and the sauce with each other and a liquid, like milk, cream, water, broth (e.g., fish, chicken or beef), mixtures thereof or the like to produce a mixture comprising buffered meal component. The amount of liquid used in the mixture comprising buffered meal component is from about 1.0 part to about 3.0 parts, and preferably, from about 1.20 parts to about 2.75 parts, and most preferably, from about 1.30 parts to about 2.5 parts of liquid for about every 1.0 part of buffered meal component plus sauce, whereby parts are parts by weight.

It is noted that the consumer may prepare the mixture comprising buffered meal component in a pot or pan suitable for use on a stove top, or microwave oven, or in a baking pan suitable for use in an oven. The buffered meal component, sauce and liquid that make up the mixture comprising buffered meal component only have to be cooked once by the consumer to produce a meal that looks and tastes fresh, wherein the preparation time for such a meal is less than about 40 minutes, and often, from about 25 minutes to about 35 minutes when medium heat is used on the stove top for stove top applications and the thermostat is set at about 160° C. to about 190° C. for oven applications. Such a meal may often be prepared for serving in under about 15 minutes when a microwave oven is employed.

The kit of the present invention successfully results in a fresh looking and excellent tasting meal because superior ingredients, like those commonly used by food companies such as Unilever Bestfoods, are employed. Additionally, the sauces used in the present invention are packaged at a pH from about 3.5 to 4.5 and not subjected to temperatures that exceed about 100° C. Such a sauce is concentrated with flavor, and unexpectedly, when combined with buffered meal component, as described herein, buffering agent leaches from the buffered meal component (rendering the buffered meal component substantially free of buffering agent) to the sauce to thereby increase the pH of the sauce (to about 4.85 to about 5.75, and preferably, to about 5.0 to about 5.6), resulting in a superior looking and tasting meal.

The following examples are provided to facilitate an understanding of the present invention. The examples are not intended to limit the scope of the claims.

### EXAMPLE 1

Buffered meal components, in the form of pasta, were prepared by mixing the following ingredients:

| Ingredient | Weight Percent (%) |
|---|---|
| Semolina Flour | 70.0-73.0 |
| Sodium Carbonate | 1.90-2.0 |
| Water | 20.0-22.0 |
| Olive Oil | 5.0-5.3 |

The resulting mixtures were extruded in a commercially available pasta machine to produce buffered ziti pasta.

### EXAMPLE 2

The following sauces (not subjected to temperatures that exceed about 100° C. and having a pH of about 4.1) were made by mixing the following ingredients:

| Ingredients | Weight Percent (%) |
|---|---|
| Tomato Paste | 58.0-61.0 |
| Alfredo Mix* | 26.0-29.0 |
| Sugar | 2.0-3.0 |
| Salt | 3.0-4.0 |
| Romano Cheese | 0.6-0.9 |
| Parmasian Cheese | 0.6-0.9 |
| Onion Powder | 0.5-0.6 |
| Garlic Powder | 0.3-0.4 |
| Granulated Onion | 0.6-0.9 |
| Granulated Garlic | 0.6-0.9 |
| Parsley | 0.1-0.2 |

*Made commercially available by unilever Bestloods.

### EXAMPLE 3

About 100.0 grams of the pasta prepared in Example 1 were mixed (in pans) with about 126.0 grams of the sauce of Example 2 and about 360 grams of water, producing mixtures comprising buffered meal component. The mixtures were cooked for about 30 minutes, those prepared on stove tops were cooked on medium heat and those baked in an oven were baked at about 177° C. The resulting meals looked fresh, and were excellent tasting. The resulting cooked sauces had a pH of about 5.0.

What is claimed is:

1. A buffered meal component comprising from about 0.1% to about 3.5% by weight of a buffering agent.

2. The buffered meal component according to claim 1 wherein the buffered meal component is a carbohydrate-based product, meat, vegetable, fruit or mixture thereof.

3. The buffered meal component according to claim 1 wherein the meal component is a carbohydrate-based product and the-carbohydrate-based product is pasta.

4. The buffered meal component according to claim 1 wherein the buffering agent is sodium citrate, sodium malate, sodium phosphate, disodium phosphate, sodium carbonate, sodium hexametaphosphate, potassium citrate, potassium phosphate, potassium carbonate, potassium bicarbonate, potassium hexametaphosphate, potassium malate, glucono-delta lactone, buffering salts of food acids or mixture thereof.

5. The buffered meal component according to claim 1 wherein the buffered meal component is suitable to increase the pH of a sauce having a pH from about 3.5 to about 4.5.

6. A kit comprising:
a) a buffered meal component;
b) a sauce;
c) instructions to combine the buffered meal component with the sauce and a liquid to produce a mixture comprising buffered meal component; and
d) instructions to cook the mixture comprising the buffered meal component.

7. The kit according to claim 6 wherein the buffered meal component is a carbohydrate-based product, meat, vegetable, fruit or a mixture thereof, having been buffered with a buffering agent.

8. The kit according to claim 7 wherein the buffering agent is sodium citrate, sodium malate, sodium phosphate, disodium phosphate, sodium carbonate, sodium hexametaphosphate, potassium citrate, potassium phosphate, potassium carbonate, potassium bicarbonate, potassium hexametaphosphate, potassium malate, glucono-delta lactone, buffering salts of food acids or mixture thereof.

9. The kit according to claim 7 wherein the buffered meal component is a carbohydrate-based product and the carbohydrate-based product is pasta.

10. The kit according to claim 6 wherein the liquid is milk, cream, water, broth or a mixture thereof.

11. The kit according to claim 6 wherein the sauce has a pH from about 3.5 to about 4.5.

12. The kit according to claim 6 wherein the kit comprises about 1.0 part buffered meal component for about every 0.5 to 1.5 parts of sauce.

13. The kit according to claim 6 wherein the instructions suggest adding a volume of liquid that equals about 1 to 3 times the weight of the buffered meal component plus the sauce.

14. The kit according to claim 6 wherein the instructions suggest to cook the mixture comprising the buffered meal component either on a stove top microwave oven, or in an oven for a period that does not exceed 40 minutes.

15. A method for making a meal comprising the steps of:
(a) combining a sauce, a buffered meal component and a liquid to produce a mixture comprising a buffered meal component;
(b) cooking the mixture comprising the buffered meal component to produce a meal.

16. The method for making a meal according to claim 15 wherein the buffered meal component is a carbohydrate-based product, meat, vegetable, fruit or mixture thereof, and the buffered meal component is buffered with about 0.1% to about 3.5% by weight of a buffering agent which is sodium citrate, sodium malate, sodium phosphate, disodium phosphate, sodium carbonate, sodium hexametaphosphate, potassium citrate, potassium phosphate, potassium carbonate, potassium bicarbonate, potassium hexametaphosphate, potassium malate, glucono-delta lactone, buffering salts of food acids or mixture thereof.

17. The method for making a meal according to claim 15 wherein the sauce has a pH from about 3.5 to about 4.5 prior to cooking, and a pH from about 4.85 to about 5.75 after cooking.

18. The method for making a meal according to claim 15 wherein the sauce is alfredo-based, teriyaki-based, cheddar-based or tomoato-based.

19. The method for making a meal according to claim 16 wherein the buffered meal component is carbohydrate-based and the carbohydrate-based buffered meal component is pasta.

20. A meal made by the method of claim 15.
